(19) United States
(12) Patent Application Publication
(10) Pub. No.: US 2026/0155588 A1
(43) Pub. Date: Jun. 4, 2026

(54) ELECTRICAL TERMINAL, ELECTRICAL FEED-TROUGH TERMINAL, SYSTEM AND METHOD OF ASSEMBLING THE SYSTEM

(71) Applicant: TE Connectivity Solutions GmbH, Schaffhausen (CH)

(72) Inventors: Romain VILLARD, Saint Priest (FR); Geoffrey MOINE, Saint Priest (FR)

(21) Appl. No.: 19/384,388

(22) Filed: Nov. 10, 2025

(30) Foreign Application Priority Data
Nov. 11, 2024 (EP) 24212093.9

(51) Int. Cl. H01R 4/48; H01R 4/2429; H01R 4/247; H01R 43/26

(52) U.S. Cl. CPC H01R 4/48275; H01R 4/2429; H01R 4/247; H01R 4/4842; H01R 4/4844; H01R 4/48455; H01R 43/26

(57) ABSTRACT

An electrical terminal, an electrical feed-trough terminal, a system and a method of assembling the system, are provided wherein the electrical terminal includes a busbar, a spring clamp and a blade arrangement, wherein the blade arrangement has at least a first blade which adjoins a cutting groove with a groove base, wherein the blade arrangement is arranged in an inclined manner with regard to a plug-in axis, wherein the spring clamp comprises a conductor feed-through section with a first recess and a pressure bar, wherein the pressure bar is arranged between a free end of the conductor feed-through section and the first recess, wherein the busbar is connected to the blade arrangement and to the spring clamp, and wherein the spring clamp may be bent at least between a first spring shape and a second spring shape differing from the first spring shape.

### CROSS REFERENCE TO RELATED APPLICATIONS

This application claims the benefit of EP Application No. 24212093.9, filed 11 Nov. 2024, the subject matter of which is herein incorporated by reference in its entirety.

### BACKGROUND OF THE INVENTION

The invention relates to an electrical terminal according to claim 1, preferably an IDC-terminal, an electrical feed-trough terminal according to claim 8, a system according to claim 9 and a method according to claim 10 of assembling the system.

WO 2012/012203 teaches an insulation displacement connector (IDC). There is a need for an improved electrical terminal, an improved electrical feed-trough terminal, an improved system and an improved method of assembling the system.

### BRIEF DESCRIPTION OF THE INVENTION

In various embodiments, an improved electrical terminal, an improved electrical feed-trough terminal, an improved system and an improved method of assembling the system are provided

In an embodiment, an improved electrical terminal, preferably an IDC-terminal, to contact an electrical cable, comprises a busbar, a spring clamp and a blade arrangement. The blade arrangement has at least a first blade which adjoins a cutting groove having a groove base. The blade arrangement is arranged in an inclined manner with regard to a plug-in axis. The spring clamp comprises a conductor feed-through section with a first recess and a pressure bar. The pressure bar is arranged between a free end of the conductor feed-through section and the first recess. The busbar is connected to the blade arrangement and to the spring clamp. The spring clamp may be bent at least between a first spring shape and a second spring shape which differs from the first spring shape. In the second spring shape, the spring clamp is tensioned and the pressure bar is arranged at such a distance to the cutting groove that the cable may be introduced along the plug-in axis through the first recess and the blade arrangement. In the first spring shape, the spring clamp is tensioned in a reduced manner compared to the second spring shape and the pressure bar is arranged closer to the cutting grove than in the second spring shape.

This embodiment has the advantage that the electrical terminal, especially an IDC-terminal, may be prepared for the electrical cable with a simple tool, for example a screwdriver, to provide a quick and robust electrical connection between the cable and the electrical terminal. Furthermore, the electrical terminal is vibration-resistant and the electrical cable is mounted in the electrical terminal in a robust manner.

By using the tensioned spring clamp, the spring clamp may push the cable which is introduced through the first recess and the pressure bar and the blade arrangement into the cutting groove by means of a pressure bar, so that the blades perforate the electrical cable and contact a conductor of the electrical cable.

In a further embodiment, the blade arrangement comprises a first blade and a second blade arranged opposite to the first blade. The first blade and the second blade may be arranged substantially in the plane which is inclined, in particular perpendicular, with regard to the plug-in axis. The first blade and the second blade are arranged on both sides of the cutting groove and are connected to each other at the groove base by means of a first connecting section. The cutting groove is open on the side facing the pressure bar. This has the advantage that the pressure bar may push the cable into the cutting groove through the opened side of the cutting groove so that on both sides of the cable the blades may perforate the electrical cable and may contact a conductor of the electrical cable on both sides.

In a further embodiment, the cutting groove comprises a groove opening, which is arranged on a side facing the pressure bar, wherein the cutting groove narrows from the groove opening towards the groove base. This has the advantage that the cables have tolerances regarding a radial direction and that, through the narrowing cutting groove, it is secured that the cutting blades may perforate the electrical cable and may contact the electrical conductor because the push bar pushes the electrical cable so far into the cutting groove until the cutting blades contact the electrical cable.

In a further embodiment, the spring clamp has a spring section and a fastening section, wherein the spring section is curved and connects the conductor feed-through section to the fastening section. The fastening section has a second recess. The busbar engages through the first recess and the second recess, so that the spring clamp is electrically and mechanically connected to the busbar.

The spring clamp comprises an actuating surface on a side facing away from the blade arrangement, wherein an actuating force may be introduced into the spring clamp via the actuating surface to tension and bend the spring clamp from the first spring shape into the second spring shape. The actuating force may be, for example, provided by a tool, preferably a screwdriver, so that the tensioning may be easily performed.

In a further embodiment, the electrical terminal comprises a housing. The housing defines a housing interior into which a cable receptacle and a tool receptacle of the housing, which are arranged offset with regard to the cable receptacle, open. The cable receptacle extends along the plug-in axis. The cutting groove and the cable receptacle overlap along the plug-in axis. The tool receptacle overlaps with the actuating surface along the plug-in axis. This has the advantage that the cable may be introduced through the cable receptacle in a linear movement and the cable receptacle guides the cable to the first recess and the blade arrangement in the movement. This has the advantage that the tool receptacle guides the tool when it is introduced into the housing.

The housing has a housing side, which is arranged outwardly from the housing interior, wherein the cable receptacle and the tool receptacle both open on the housing side. This has the advantage that the cable and the tool may be introduced into the housing from one side and so the other sides of the housing may be arranged to other components.

An improved electrical feed-through terminal may comprise a first electrical terminal, a second electrical terminal and a connecting busbar. The first electrical terminal and the second electrical terminal are both embodied according to the above-described electrical terminal. The connecting busbar connects the busbar of the first electrical terminal to the busbar of the second electrical terminal. The busbar of the first electrical terminal, the busbar of the second electrical terminal and the connecting busbar may be formed in one piece and from one material. The electrical feed-through terminal has the advantage that a good and robust connection may be provided from one cable to another cable via the feed-through terminal.

An advantageous system may comprise an electrical terminal and an electrical cable. The electrical terminal is embodied as described above. The electrical cable comprises an electrical conductor and a cable insulation electrically insulating the electrical conductor, wherein the spring clamp is bent into the first spring shape. The electrical cable extends through the first recess and the cutting groove. The first blade engages through the cable insulation and contacts the first electrical conductor. The pressure bar secures the electrical cable in the cutting groove.

In a further embodiment, in the second spring shape of the spring clamp, the spring clamp is bent in such a way that the cable may be introduced along the plug-in axis through the first recess and next the blade arrangement.

In an advanced method of assembling the system, the electrical cable and the electrical terminal are provided. A tension force is introduced into the spring clamp to bend and tension the spring clamp into the second spring shape. The electrical cable is routed through the first recess along the plug-in axis and is arranged next to the blade arrangement. The tension force is released and the spring clamp relaxes and the pressure bar of the spring clamp presses the electrical cable into the cutting groove. The first blade penetrates the cable insulation and electrically contacts the first electrical conductor. This method has the advantage that the electrical connection between the electrical cable and the electrical terminal is determined quickly. Furthermore, with the aid of this method, the blade arrangement may be made from several materials including copper, so that the blade arrangement and therefore the electrical terminal may be produced in a cost-effective manner.

In a further embodiment, a tool, particularly a screwdriver, is inserted into the tool receptacle and a tip of the tool contacts the spring clamp with the tension force. The electrical cable is inserted through the first recess via the cable receptacle, wherein the tool is removed from the tool receptacle to release the tension force.

### BRIEF DESCRIPTION OF THE DRAWINGS

The invention is described in conjunction with the following figures, in which

FIG. 1 A and FIG. 1B show perspective illustrations of an electrical system according to a first embodiment;

FIG. 2 shows a perspective view of the system shown in the FIGS. 1A and 1B;

FIG. 3 shows a section A marked in FIG. 2 of the system;

FIG. 4 shows a sectional view along a sectional plane C-C shown in FIG. 3 through the system;

FIG. 5 shows a sectional view along a sectional plane C-C shown in FIG. 3 through the system;

FIG. 6 shows a sectional view along a sectional plane C-C shown in FIG. 3 through the system;

FIG. 7 shows flow chart of a method for mounting the system shown in the previous FIGS. 1A to 6;

FIG. 8 shows a perspective view of a system according to a second embodiment; and

FIG. 9 shows a sectional view along a sectional plane D-D through the system shown in FIG. 8.

### DETAILED DESCRIPTION OF THE INVENTION

Reference is made in the following Figures to a coordinate system for easier understanding. The coordinate system has an x-axis, a y-axis and a z-axis. The coordinate system here, for example, is depicted as a right-handed system.

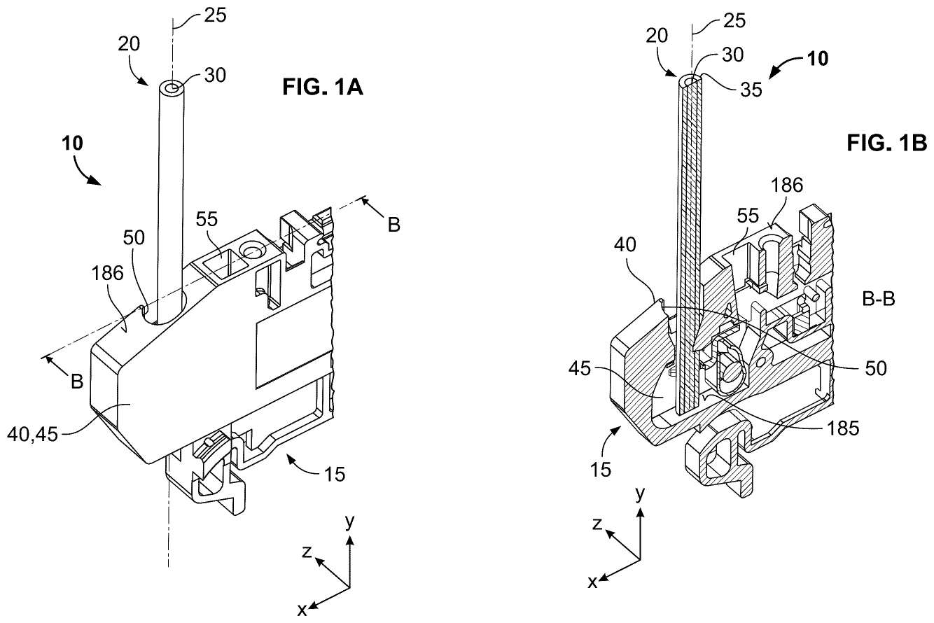

FIG. 1A and FIG. 1B each show a perspective illustration of an electrical system 10 according to a first embodiment.

The system 10 comprises an electrical terminal 15 and an electrical cable 20. The electrical terminal 15 may for example be an input terminal or an output terminal. The electrical terminal 15 may, for example, be an input or output terminal and may also form part of a terminal module with several electrical terminals 15, arranged, for instance, in a row. The electrical cable 20 extends along a plug-in axis 25, which runs in parallel with regard to the y-axis.

The electrical cable 20 comprises an electrical conductor 30 and a cable insulation 35. The cable insulation 35 electrically insulates the electrical conductor 30 and extends completely around the electrical conductor 30. The electrical conductor 30 may be wire-shaped or may be braided. The electrical conductor 30 comprises an electrically conductive material such as copper and/or aluminum.

The electrical terminal 15 is preferably embodied as an IDC (insulation displacement connector)-terminal.

The electrical terminal 15 has a housing 40. The housing 40 defines a housing interior 45 and includes a cable receptacle 50 and a tool receptacle 55. In the first embodiment, for example, the cable receptacle 50 and the tool receptacle 55 are arranged on the same side of the housing 40 and are offset in the x-direction. The cable receptacle 50 extends along the plug-in axis 25, and the tool receptacle 55 may extend in parallel with regard to the cable receptacle 50. The tool receptacle 55 and the cable receptable 50 are preferably opened on an identical housing side 186, which is arranged outwards of the housing interior 45. On the opposite side of the cable receptacle 50, the housing includes a stop surface 185 located on the inside of the housing 40.

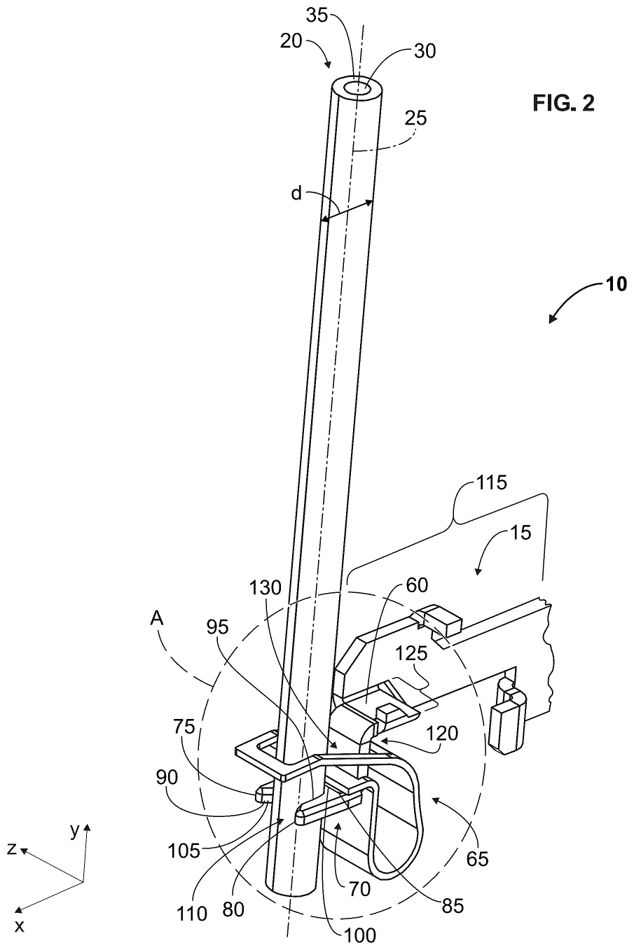

FIG. 2 shows a perspective view of the system 10 shown in the FIG. 1A and FIG. 1B.

In FIG. 2, the housing 40 is not shown for reasons of clarity.

The electrical terminal 15 comprises a busbar 60, a spring clamp 65 and a blade arrangement 70. The blade arrangement 70 is preferably arranged in an inclined manner, vertically with regard to the plug-in axis 25, and may extend, for example, in an xz-plane.

The blade arrangement 70 comprises, for example, a first blade 75, a second blade 80 and a first connecting section 85. The first blade 75 and the second blade 80 are arranged opposite to each other (in z-direction) and are connected with the first connecting section 85 on one side. The first connecting section 85 may be plate-shaped and is positioned at a cutting groove 110.

The first blade 75 comprises a first cutting edge 90 and the second blade 80 comprises a second cutting edge 95, wherein the first cutting edge 90 is arranged on a side facing the second blade 80 of the first blade 75. The second cutting edge 95 is arranged on a side facing the first blade 75. The first cutting edge 90 and the second cutting edge 95 define the cutting groove 110 in z-direction.

The cutting groove 110 furthermore comprises a groove base 100, wherein the groove base 100 is arranged at the first connecting section 85 and is limited by the first connecting section 85. On an opposite side (in x-direction) of the groove base 100, the blade arrangement 70 defines a groove opening 105, wherein the groove opening 105 is arranged between free ends of the first blade 75 and the second blade 80. In a preferred embodiment, the cutting groove 110 narrows starting from the groove opening 105 in x-direction to the groove base 100. The cable 20 comprises an outer diameter d.

In a mounted state of the system 10, the electrical cable 20 extends along the plug-in axis 25 through the cutting groove 110. The first blade 75 engages through the cable insulation 35 and contacts the electrical conductor 30 with the first cutting edge 90. The second blade 80 engages through the cable insulation 35 on an opposite side of the first blade and contacts the electrical conductor 30 with the second cutting edge 95. The first cutting edge 90 and the second cutting edge 95 may penetrate the first electrical conductor 30 tangentially so that an outer surface of the electrical conductor 30 and, for example, an oxide layer, for example of aluminum oxide, may be perforated to provide a good mechanical and electrical contact between the blade arrangement 70 and the electrical conductor 30.

The busbar 60 is mechanically as well as electrically connected to the blade arrangement 70. The busbar 60 comprises a first section 115 and, for example, a second section 120, wherein, for example, the first section 115 is plate-shaped and extends in an xy-plane.

On a side facing the blade arrangement 70, the second section 120 is connected with the first section 115. The second section 120 is arranged in an inclined manner with regard to the first section 115, for example. The second section 120 may, for example, be L-shaped and is, on one side, connected to the blade arrangement 70 at the first connecting section 85 of the blade arrangement 70.

The second section 120 comprises a second connecting section 125 and a feed-through-section 130. The feed-trough section 130 is directly connected to the blade arrangement 70 and extends, for example, in a plane, for example in an yz-plane. The feed-trough section 130 is connected on opposite sides to the blade arrangement 70 with the second connecting section 125 wherein the second connecting section 125 is connected with the first section 115 on one side. The second connecting section 125 is arranged in an inclined manner, preferably perpendicular, to the feed-trough section 130 and may be arranged in an xz-plane, for example. The feed-trough section 130 and the second connecting section 125 may be arranged in an inclined manner with regard to each other, for example, perpendicular with regard to each other.

In a preferred embodiment, at least the first section 115 and the second section 120 are made, for example, from sheet material, ideally a thin-walled electrically conductive sheet material. The busbar 60 may, for example, be produced in a stamping and bending process.

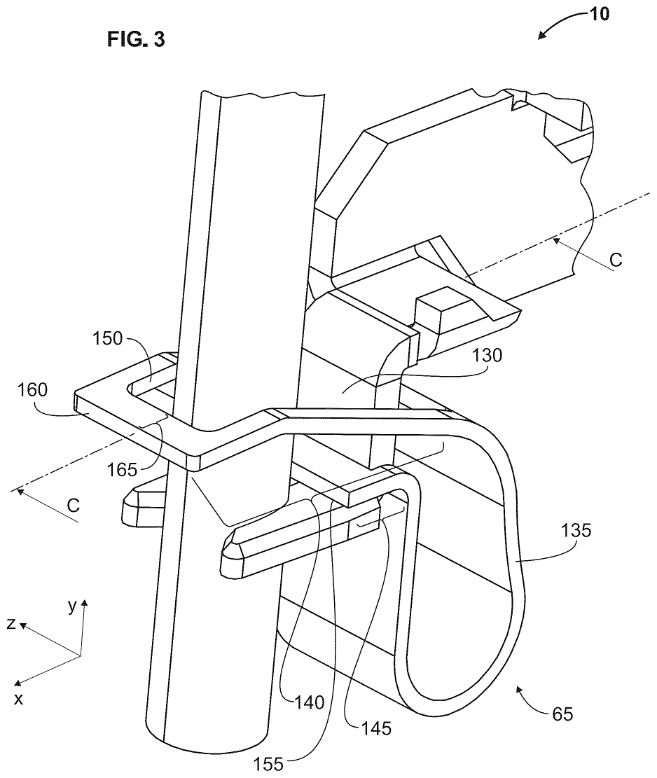

FIG. 3 shows a section A of the system 10 marked in FIG. 2.

The spring clamp 65 comprises a spring section 135, a conductor feed-trough section 140 and a fastening section 145.

The spring section 135 is curved and may extend around 180° to 270° about the z-axis. The spring clamp 65 is made from one piece and one material and may be made from sheet material, for example spring steel.

On one side, the spring section 135 is connected with the fastening section 145, wherein the fastening section 145 is arranged in an inclined manner, preferably perpendicular to the spring section 135 at a first end of the spring section 135. On the other side opposite to the first side of the spring section 135, the conductor feed-trough section 140 is directly connected to the spring section 135. The conductor feed-trough section 140 extends in the same direction as the fastening section 145 away from the spring section 135, wherein the conductor feed-trough section 140 and the fastening section 145 are arranged in y-direction at a distance. The conductor feed-through section is longer in y-direction than the fastening section 145. The spring section 135 connects the conductor feed-trough section 140 with the fastening section 145.

The conductor feed-through section 140 comprises a first recess 150 and, for example, the fastening section 145 comprises a second recess 155. The second recess 155 is slot-shaped and may be arranged directly at the transition between the fastening section 145 and the spring section 135. The second recess 155 may be embodied corresponding to the feed-trough section 130.

The first recess 150 of the conductor feed-through section 140 extends starting from the transition between the spring section 135 to a free end 160 of the conductor feed-trough section 140 and ends at a distance to the free end 160 of the conductor feed-trough section 140. The first recess 150 has the form of an angulated hole and its main direction is along the x-axis. The first recess 150 extends in y-direction through the conductor feed-trough section 140.

The conductor feed-trough section 140 comprises a pressure bar 165 between the first recess 150 and the free end 160 of the conductor feed-trough section 140. The pressure bar 165 closes the first recess 150 towards the free end 160 of the conductor feed-trough section 140.

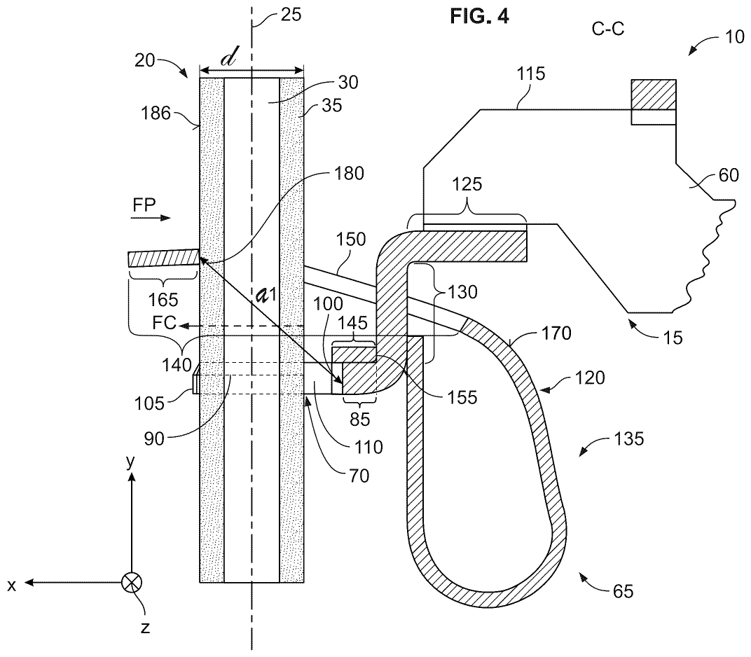

FIG. 4 shows a sectional view along a sectional plane C-C shown in FIG. 3 through the system 10.

In FIG. 4, it is clearly shown that the spring section 135 is U-shaped and extends around between 180° and 270°. The main deformation of the spring clamp 65 may be done in the spring section 135.

In the mounted state of the electrical terminal 15, the feed-trough section 130 of the busbar 60 engages with the first recess 150 of the conductor feed-trough section 140 and with the second recess 155 of the fastening section 145. The blade arrangement 70 may rest at the first connecting section 85 against the fastening section 145 on the opposite side of the conductor feed-trough section 140. The blade arrangement 70 may be connected to the fastening section 145, for example by means of a welding-connection or a soldered connection.

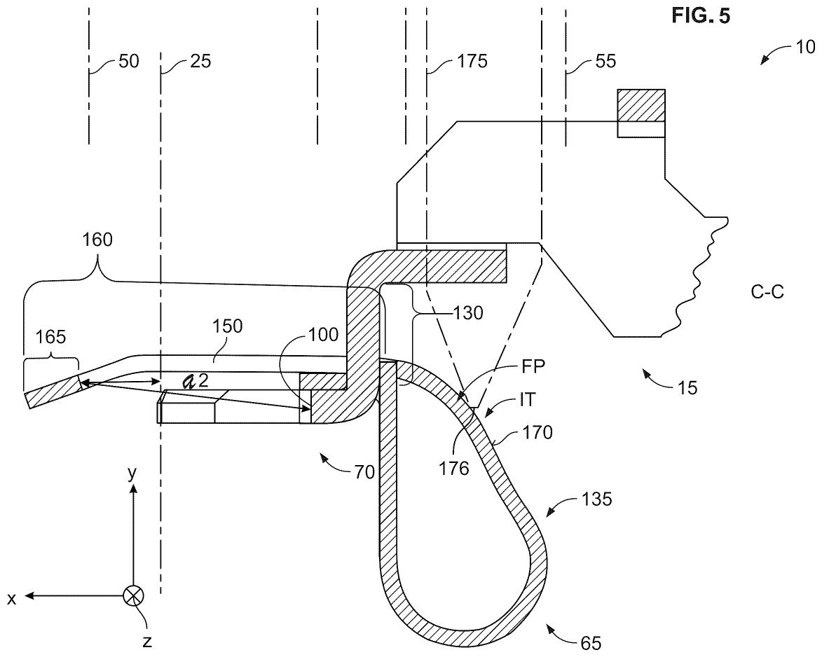

The spring clamp 65 may be deformed and comprises at least a first spring shape (shown in FIG. 4) and at least a second spring shape (shown in FIG. 5) differing from the first spring shape. In the mounted state of the system 10, the spring clamp 65 comprises the first spring shape. In the first spring shape, the spring clamp 65, mainly in the spring section 135, is tensioned and the first recess 150 and the cutting groove 110 partially overlaps along the plug-in axis 25. An overlap along the plug-in axis 25 means that if two components, for example the first recess 150 and the cutting groove 110, are projected along the plug-in axis 25 in a projection plane perpendicular to the plug-in axis, for example an xz-plane, the two components, for example the first recess 150 and the cutting groove 110, overlap in the projection plane. Specifically, in the first spring shape, there is only a partial overlap between the first recess 150 and the cutting groove 110. Furthermore, there may be an overlap along the plug-in axis 25 between the cutting groove 110 and the pressure bar 165.

With an inner surface 180, the pressure bar 165 contacts an outer circumferential surface 186 of the cable insulation 35. The inner surface 180 borders on the first recess 150 in x-direction on a side opposite to the spring section 135. The inner surface 180 is arranged at a minimal first distance a1 to the groove base 100.

In the first spring shape, the spring section 135 is tensioned and provides a pressure force FP at the pressure bar 165 against the cable insulation 35 of the electrical cable 20. The pressure force FP is orientated at an angle to the plugin-axis 25 and presses the electrical cable 20 into the cutting groove 110 to secure the electrical cable 20 in the cutting groove 110 and to provide a good and a vibration-resistant connection between the blade arrangement 70 and the electrical conductor 30. Furthermore, a movement of the electrical cable 20 along the plug-in axis 25 is blocked by the penetration of the first and second cutting edge 90, 95 into the electrical conductor 30.

The spring section 135 comprises an actuating surface 170 which is arranged on an outer surface of the spring section 135 facing away from the blade arrangement 70.

FIG. 5 shows a sectional view along a sectional plane C-C, as shown in FIG. 3, through the system 10.

In FIG. 5, the spring clamp 65 is tensioned and bent into the second spring shape mainly in the spring section 135. In the second spring shape, the spring section 135 ring-shaped and/or has a closed shape so that, for example, the spring section 135 contacts the beginning of the first recess 150 on the other side of the spring section 135 which is arranged directly next to the feed-trough section 130. Furthermore, the feed-trough section 130 is arranged closer to the blade arrangement 70 and may be positioned at least in some sections in parallel with regard to the blade arrangement 70.

Additionally, the actuating surface 170 comprises an overlap with the first tool receptacle 55 along the plug-in axis 25. Preferably, in the first spring shape and the second spring shape, the actuating surface 170 is arranged at least partially at an angle to the plug-in axis 25.

With the aid of a tool 175, especially a screwdriver, but it could also be other bolt-shaped tools, a tension force FT may be introduced into the actuating surface 170 to tension the spring section 135 and bend the spring clamp 65 into the second spring shape.

In the second spring shape, the inner surface 180 is arranged in a second distance a2 to the groove base 100. By tensioning the spring section 135, the inner surface 180 is moved outwards away from the blade arrangement 70 in comparison to the first spring shape so that the second distance a2 is larger than the first distance a1 to the groove base 100.

Preferably, the blade arrangement 70 and the conductor feed-trough section 140 with the first recess 150 are embodied in such a way that in the second spring shape, a third minimal distance a3 between an end of the blade arrangement 70 at the grove opening 105 and the inner surface 180 in a plane perpendicular to the plug-in axis 25 is larger than the outer diameter d of the electrical cable 20.

In the second spring shape, the cutting groove 110 fully overlaps with the first recess 150. Furthermore, the first recess 150 comprises a complete overlap along the plug-in axis 25 with the cable receptacle 50.

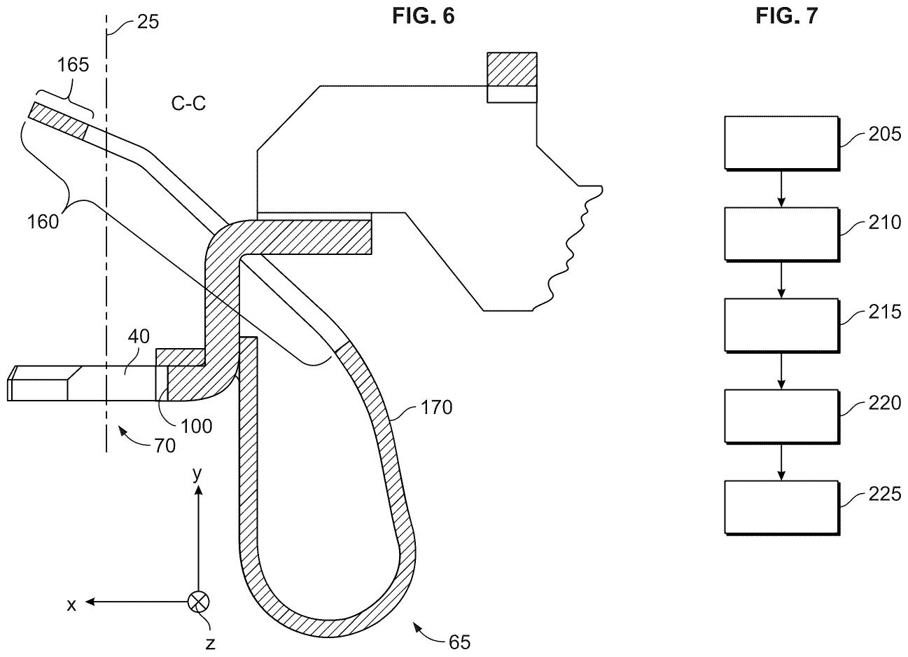

FIG. 6 shows a sectional view along a sectional plane C-C (shown in FIG. 3) through the system 10.

Furthermore, in a dismounted state of the electrical terminal 15, when the electrical cable 20 is not mounted at the electrical terminal 15, the spring clamp 65 may bend into a third spring shape which is shown in FIG. 6. The third spring shape of the spring clamp 65 is delimited by the design of the housing 40 and the form of the housing interior 45. In the third spring shape of the third spring clamp 65, the spring clamp 65 is relaxed and does not provide the pressure force FP at the pressure bar 165. In the third spring shape of the spring clamp 65, the conductor feed-trough section 140 may be pivoted away from the blade arrangement 70. In the third spring shape, the pressure bar 165 may be arranged with a partial or a full overlap along the plug-in axis 25 with the cutting groove 110.

FIG. 7 shows a flow chart of a method of mounting the system 10 shown in the previous FIGS. 1A to 6.

In a first assembling step 205, the electrical terminal 15 and the electrical cable 20 are provided. In the first assembling step 205, the spring clamp 65 may be in the third spring shape shown in FIG. 6 and is relaxed. Furthermore, the electrical conductor 30 of the electrical cable 20 is fully insulated by the cable insulation 35 in the radial direction.

In a second assembling step 210, following the first assembling step 205, the tool 175, for example the screwdriver, is inserted along the plug-in axis 25 into the cable receptacle 50 and is pushed along the plug-in axis 25 against the actuating surface 170 of the spring section 135 (cf. FIG. 5). In this process, the tool 175 presses against the actuating surface 170 with the tension force FT and tensions the relaxed spring clamp 65 from the third spring shape (shown in FIG. 6) over the first spring shape (shown in FIG. 4) into the second spring shape (shown in FIG. 5). In the second spring shape, the spring clamp 65 is most tensioned.

In a third assembling step 215, following the second assembling step 210, the electrical cable 20 is cut to its desired length at one end and is introduced along the plug-in axis 25 with its cable insulation 35 through the cable receptacle 50 and the first recess 150.

The electrical cable 20 is plugged into the cable receptacle 50. During the plug-in of the electrical cable 20, the end of the electrical cable 20 passes through the first recess 150 and passes sideways of the blade arrangement 70 until, for example, the end of the electrical cable 20 is arranged at or between the stop surface 185 and the blade arrangement 70 along the plug-in axis 25.

The electrical cable 20 may be plugged so far into the cable receptacle 50 and the housing interior 45 until an end of the electrical cable 20 contacts to the stop surface 185 of the housing 40, wherein with regard to the plug-in axis 25 the blade arrangement 70 is arranged between the first recess 150 and the stop surface 185.

During the third assembling step 215, the tool 175 remains in the first tool receptacle 55 and still provides the tension force FT to keep the spring clamp 65 during the plug-in of the electrical cable 20 in the second spring shape.

In a fourth assembling step 220, following the third assembling step 215, the tool 175, especially the screwdriver, is pulled out of the first tool receptacle 55 and the housing interior 45, so that the tool 175 is no longer in contact with the actuating surface 170 and the tool 175 does not provide the tension force FT anymore.

In a fifth assembling step 225, the spring clamp 65 relaxes compared to the second spring shape and provides the pressure force FP at the pressure bar 165. With the pressure force FP, the pressure bar 165 pushes the electrical cable 20 in the direction of the blade arrangement 70, so that the electrical cable 20 is displaced in x-direction perpendicular to the plug-in axis 25 from an area sideways of the blade arrangement 70 into the cutting groove 110 of the blade arrangement 70. During the displacement, the first cutting edge 90 and the second cutting edge 95 penetrate the cable insulation 35 and contact the electrical conductor 30 of the electrical cable 20.

During the displacement of the electrical cable 20, the conductor feed-trough section 140 may pivot and/or move towards the blade arrangement 70 so that the second minimal distance a2 between the inner surface 180 and the groove base 100 reduces and the electrical cable 20 may move into the cutting groove 110.

During the penetration of the first and second cutting edge 90, 95 into the cable insulation 35 and the direct contact with the electrical conductor 30, the electrical cable 20 provides a counter force FC directed in opposite direction to the direction of the pressure force FP. When the counter force FC and the pressure force FP reach a state of balance, the displacement of the electrical cable 20 into the blade arrangement 70 in the direction of the groove base 100 stops.

In this stage, the spring clamp 65 has reached the first spring shape and the system 10 is mounted.

It is the advantage of the system 10 that the electrical connection between the electrical conductor 30 and the electrical terminal 15 is vibration-resistant and the electrical cable 20 may be connected to the electrical terminal 15 without removing a section of the cable insulation 35 from the electrical conductor 30, so that after cutting the electrical cable 20 no further preparing steps are required before the electrical cable 20 may be introduced into the electrical terminal 15 to connect the electrical cable 20 with the electrical terminal 15.

Furthermore, no special tool 175 is necessary in order to open the spring clamp 65 and to bring the spring clamp 65 into the second spring shape, so that the electrical cable 20 may be pushed along the plug-in axis 25 into its stop position wherein the electrical cable 20 is guided through the cable receptacle 50 through the first recess 150 and may be arranged next to the blade arrangement 70.

Furthermore, the design of the spring clamp 65, especially in the spring section 135, defines the pressure force FP and with a design change in the spring section 135, the pressure force may be easily adjusted, so that it is ensured that the spring clamp 65 is strong enough to push with the pressure bar 165 the electrical cable 20.

Furthermore, this electrical terminal 15 has the advantage that by removing the tool 175 out of the tool receptable, the spring clamp 65 automatically connects the electrical cable 20 with the blade arrangement 70 so that a good electrical connection between the electrical conductor 30 and the busbar 60 is provided.

The electrical terminal 15 further has the advantage that several materials may be used for the blade arrangement 70. In particular, it is not necessary that the blade arrangement is made of an expensive copper alloy.

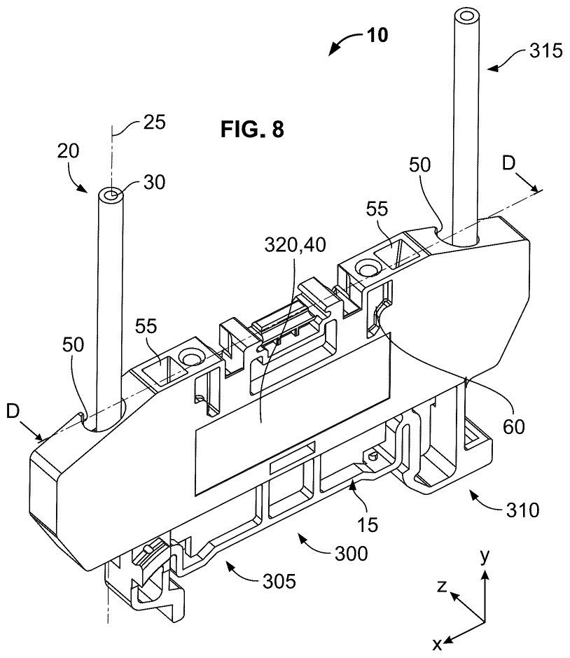

FIG. 8 shows a perspective view of a system 10 according to a second embodiment.

The system 10 comprises an electrical feed-trough terminal 300. The electrical feed-trough terminal 300 comprises a first electrical terminal 305 and a second electrical terminal 310. Furthermore, the system 10 comprises a first electrical cable 311 and a second electrical cable 315, wherein, for example, the first and second electrical cable 311, 315 are each identical to the electrical cable 20 described in FIG. 1. The first electrical cable 311 and the second electrical cable 315 are arranged, for example, in parallel with regard to each other and are arranged in distance with respect to the x-axis.

The feed-through terminal 300 comprises a feed-through housing 320. The feed-through housing 320 is made from one piece and one material. The feed-through housing integrates the housing 40 of the first electrical terminal 305 and the housing 40 the second electrical terminal 310.

On a side opposite to the tool receptacle 55 and the cable receptacle 50, the feed-through housing 320 may be connected to a DIN-rail, for example a hat rail.

The first electrical terminal 305 and the second electrical terminal 310 are identical to the electrical terminal 15 shown in FIGS. 1A to 6.

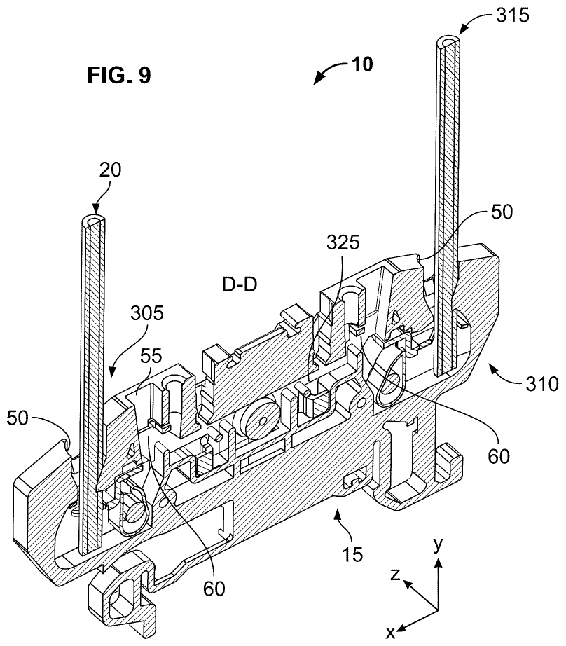

FIG. 9 shows a sectional view along a sectional plane D-D through the system 10 shown in FIG. 8.

The feed-trough terminal 300 additionally comprises a connecting busbar 325, wherein the connecting busbar 325 is on one side connected to the busbar 60 of the first electrical terminal 305 and on the opposite side to the busbar 60 of the second electrical terminal 310. In a preferred embodiment, the connecting busbar 325, the busbar of the first electrical terminal 305, and the busbar 60 of the second electrical terminal 310 are made from one piece. Thereby, the connecting busbar 325 electrically and mechanically connects the busbar 60 of the first electrical terminal 305 and the busbar 60 of the second electrical terminal 310.

The method of mounting the feed-trough terminal 300 is carried out for each of the first and second electrical terminals 305, 310 according to the method described in FIG. 7. The method of mounting the second electrical terminal 310 only has to be adopted in order to achieve that instead of the first electrical cable 311, the second electrical cable 315 is introduced into the cable receptacle 50 of the second electrical terminal. The first electrical cable 311 and the second electrical cable 315 may be independently connected to the corresponding electrical terminal 305, 310 and the tool 175 may be used both to connect the first electrical cable 311 and the second electrical cable 315 to the feed-trough terminal 300.

The feed-trough terminal 300 has a very robust design, and the connection between the first electrical cable 311 and the second electrical cable 315 may be established quickly. Furthermore, only a tool 175 which is bolt-shaped, preferably a screwdriver, is required to introduce the corresponding cable 20, 315 in the corresponding cable receptacle 50 and to establish a good electrical and mechanical connection between the electrical cable 20, 315 and the feed-trough terminal 300.

Furthermore, the electrical connection between the electrical conductor 30 of the first electrical cable 311 and the second electrical conductor of the second electrical cable 315 has a low resistance and is secure.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical terminal for contacting an electrical cable, the electrical terminal comprising:
a busbar, a spring clamp and a blade arrangement,
wherein the blade arrangement has at least a first blade which adjoins a cut-ting groove having a groove base,
wherein the blade arrangement is arranged in an inclined manner with regard to a plug-in axis,
wherein the spring clamp comprises a conductor feed-through section with a first recess and a pressure bar,
wherein the pressure bar is arranged between a free end of the conductor feed-through section and the first recess,
wherein the busbar is connected to the blade arrangement and to the spring clamp,
wherein the spring clamp is bent at least between a first spring shape and a second spring shape differing from the first spring shape,
wherein in the second spring shape, the spring clamp is tensioned and the pressure bar is arranged at a second minimal distance to the cutting groove,
wherein in the first spring shape, the spring clamp is tensioned in a reduced manner compared to the second spring shape and the pressure bar is arranged closer to the cutting groove than in the second spring shape.

2. The electrical terminal according to claim 1,
wherein the blade arrangement comprises a first blade and a second blade arranged opposite to the first blade,
wherein the first blade and the second blade are arranged on both sides of the cutting groove and are connected to each other at the groove base by means of a first connecting section,
wherein the cutting groove is open on the side facing the pressure bar.

3. The electrical terminal according to claim 1,
wherein the cutting groove comprises a groove opening which is arranged on a side facing the pressure bar,
wherein the cutting groove narrows from the groove opening towards the groove base.

4. The electrical terminal according to claim 1,
wherein the spring clamp has a spring section and a fastening section,
wherein the spring section is curved and connects the conductor feed-through section to the fastening section,
wherein the fastening section has a second recess,
wherein the busbar engages through the first recess and the second recess.

5. The electrical terminal according to claim 1,
wherein the spring clamp comprises an actuating surface on a side facing away from the blade arrangement,
wherein an actuating force is introduced into the spring clamp via the actuating surface in order to tension and bend the spring clamp from the first spring shape into the second spring shape.

6. The electrical terminal according to claim 5,
wherein the electrical terminal comprises a housing,
wherein the housing defines a housing interior into which a cable receptacle and a tool receptacle of the housing, which are arranged at an offset with regard to the cable receptacle, open,
wherein the cable receptacle extends along the plug-in axis,
wherein the cutting groove and the cable receptacle overlap along the plug-in axis,
wherein the tool receptacle overlaps with the actuating surface along the plug-in axis.

7. The electrical terminal according to claim 6,
wherein the housing has a housing side, which is arranged outwards of the housing interior,
wherein the cable receptacle and the tool receptacle both open on the housing side.

8. An electrical feed-through terminal comprising:
a first electrical terminal, a second electrical terminal and a connecting busbar,
the first electrical terminal including a first busbar, a first spring clamp and a first blade arrangement, the first blade arrangement having at least a first blade which adjoins a first cutting groove having a groove base, the first blade arrangement being arranged in an inclined manner with regard to a plug-in axis, the first spring clamp including a first conductor feed-through section with a first recess and a first pressure bar, the first pressure bar being arranged between a free end of the first conductor feed-through section and the first recess, the first busbar being connected to the first blade arrangement and to the first spring clamp, the first spring clamp being bent at least between a first spring shape and a second spring shape differing from the first spring shape, wherein in the second spring shape, the first spring clamp is tensioned and the first pressure bar is arranged at a second minimal distance to the first cutting groove, and wherein in the first spring shape, the first spring clamp is tensioned in a reduced manner compared to the second spring shape and the first pressure bar is arranged closer to the first cutting groove than in the second spring shape;
the second electrical terminal including a second busbar, a second spring clamp and a second blade arrangement, the second blade arrangement having at least a second blade which adjoins a second cutting groove having a groove base, the second blade arrangement being arranged in an inclined manner with regard to a plug-in axis, the second spring clamp including a second conductor feed-through section with a second recess and a second pressure bar, the second pressure bar being arranged between a free end of the second conductor feed-through section and the second recess, the second busbar being connected to the second blade arrangement and to the second spring clamp, the second spring clamp being bent at least between a first spring shape and a second spring shape differing from the first spring shape, wherein in the second spring shape, the second spring clamp is tensioned and the second pressure bar is arranged at a second minimal distance to the second cutting groove, and wherein in the first spring shape, the second spring clamp is tensioned in a reduced manner compared to the second spring shape and the second pressure bar is arranged closer to the second cutting groove than in the second spring shape;
wherein the connecting busbar connects the busbar of the first electrical terminal to the busbar of the second electrical terminal,
wherein the busbar of the first electrical terminal, the busbar of the second electrical terminal and the connecting busbar are formed in one piece and from one material.

9. The electrical feed-through terminal according to claim 8,
wherein the first blade arrangement comprises a first blade and a second blade arranged opposite to the first blade,
wherein the first blade and the second blade are arranged on both sides of the first cutting groove and are connected to each other at the groove base by means of a first connecting section,
wherein the first cutting groove is open on the side facing the first pressure bar.

10. The electrical feed-through terminal according to claim 8,
wherein the first cutting groove comprises a groove opening which is arranged on a side facing the first pressure bar,
wherein the first cutting groove narrows from the groove opening towards the groove base.

11. The electrical feed-through terminal according to claim 8,
wherein the first spring clamp has a spring section and a fastening section,
wherein the first spring section is curved and connects the first conductor feed-through section to the fastening section,
wherein the fastening section has a second recess,
wherein the first busbar engages through the first recess and the second recess.

12. The electrical feed-through terminal according to claim 8,
wherein the first spring clamp comprises an actuating surface on a side facing away from the first blade arrangement,
wherein an actuating force is introduced into the first spring clamp via the actuating surface in order to tension and bend the first spring clamp from the first spring shape into the second spring shape.

13. The electrical feed-through terminal according to claim 12,
wherein the first electrical terminal comprises a housing,
wherein the housing defines a housing interior into which a cable receptacle and a tool receptacle of the housing, which are arranged at an offset with regard to the cable receptacle, open,
wherein the cable receptacle extends along the plug-in axis,
wherein the first cutting groove and the cable receptacle overlap along the plug-in axis,
wherein the tool receptacle overlaps with the actuating surface along the plug-in axis.

14. The electrical feed-through terminal according to claim 13,
wherein the housing has a housing side, which is arranged outwards of the housing interior,
wherein the cable receptacle and the tool receptacle both open on the housing side.

15. A system comprising:
an electrical terminal including a busbar, a spring clamp and a blade arrangement; and
an electrical cable including an electrically conductive conductor and a cable insulation electrically insulating the first electrical conductor;
wherein the blade arrangement has at least a first blade which adjoins a cut-ting groove having a groove base,
wherein the blade arrangement is arranged in an inclined manner with regard to a plug-in axis,
wherein the spring clamp comprises a conductor feed-through section with a first recess and a pressure bar,
wherein the pressure bar is arranged between a free end of the conductor feed-through section and the first recess,
wherein the busbar is connected to the blade arrangement and to the spring clamp,
wherein the spring clamp is bent at least between a first spring shape and a second spring shape differing from the first spring shape,
wherein in the second spring shape, the spring clamp is tensioned and the pressure bar is arranged at a second minimal distance to the cutting groove,
wherein in the first spring shape, the spring clamp is tensioned in a reduced manner compared to the second spring shape and the pressure bar is arranged closer to the cutting groove than in the second spring shape,
wherein the electrical cable extends through the first recess and the cutting groove,
wherein the first blade engages through the cable insulation and contacts the electrical conductor,
wherein the pressure bar secures the electrical cable in the cutting groove.

16. The system according to claim 15,
wherein in the second spring shape of the spring clamp, the spring clamp is bent in such a way that the cable is introduced along the plug-in axis through the first recess and next to the blade arrangement.

17. A method of assembling a system comprising:
providing an electrical terminal including a busbar, a spring clamp and a blade arrangement, wherein the blade arrangement has at least a first blade which adjoins a cutting groove having a groove base, the blade arrangement being arranged in an inclined manner with regard to a plug-in axis, wherein the spring clamp includes a conductor feed-through section with a first recess and a pressure bar, the pressure bar being arranged between a free end of the conductor feed-through section and the first recess, wherein the busbar is connected to the blade arrangement and to the spring clamp, wherein the spring clamp is bendable at least between a first spring shape and a second spring shape differing from the first spring shape, wherein in the second spring shape, the spring clamp is tensioned and the pressure bar is arranged at a second minimal distance to the cutting groove, and wherein in the first spring shape, the spring clamp is tensioned in a reduced manner compared to the second spring shape and the pressure bar is arranged closer to the cutting groove than in the second spring shape;
providing an electrical cable including an electrically conductive conductor and a cable insulation electrically insulating the first electrical conductor;
introducing a tension force into the spring clamp to bend and tension the spring clamp into the second spring shape;
routing the electrical cable through the first recess along the plug-in axis next to the blade arrangement;
releasing the tension force such that the spring clamp relaxes and the pressure bar presses the electrical cable into the cutting groove, penetrating the first blade through the cable insulation to electrically contact the electrical conductor.

18. The method according to claim 17, wherein the spring clamp comprises an actuating surface on a side facing away from the blade arrangement, further comprising:
introducing an actuating force into the spring clamp via the actuating surface in order to tension and bend the spring clamp from the first spring shape into the second spring shape.

19. The method according to claim 18, further comprising
providing a housing defining a housing interior into which a cable receptacle and a tool receptacle of the housing, which are arranged at an offset with regard to the cable receptacle, open, wherein the cable receptacle extends along the plug-in axis, wherein the cutting groove and the cable receptacle overlap along the plug-in axis, and wherein the tool receptacle overlaps with the actuating surface along the plug-in axis;
inserting a tool into the tool receptacle such that a tip of the tool contacts the spring clamp with the tension force to allow inserting the electrical cable through the first recess via the cable receptacle; and
removing the tool is from the tool receptacle to release the tension force.
